(19) United States
(12) Patent Application Publication
(10) Pub. No.: US 2009/0142567 A1
(43) Pub. Date: Jun. 4, 2009

(54) THERMALLY CONDUCTIVE ARAMID-BASED DIELECTRIC SUBSTRATES FOR PRINTED CIRCUIT BOARDS AND INTEGRATED CIRCUIT CHIP PACKAGING

(75) Inventors: Kuppusamy Kanakarajan, Dublin, OH (US); Ralph Hutton, Kinsale, VA (US); Christopher J. Milasincic, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. du Pont de Nemours and Company, Wilmington, DE (US)

(21) Appl. No.: 12/264,987

(22) Filed: Nov. 5, 2008

Related U.S. Application Data
(60) Provisional application No. 61/005,458, filed on Dec. 3, 2007.

(51) Int. Cl. B32B 27/06; B32B 27/36; B32B 27/34; B32B 27/00; B32B 27/32; B32B 27/30; B32B 5/16; B32B 15/08

(52) U.S. Cl. 428/220; 428/475.2; 428/473.5; 428/412; 428/476.3; 428/421; 428/422; 428/339; 428/323; 428/458

(57) ABSTRACT

The present invention relates generally to fiber-based reinforced composite sheets comprising one or more woven or non-woven para-aramid or fiberglass fabrics, sheets, or papers, impregnated with a polymeric matrix, said polymeric matrix comprising at least one polymer and a thermally conductive filler component suitable for conducting heat, the sheet being useful as a thermally conductive printed circuit board substrate or as a component in a thermally conductive integrated circuit chip package.

### FIELD OF INVENTION

The present invention is directed to fiber reinforced composite substrates (sheets) comprising one (or more) woven or non-woven para-aramid fabrics, sheets, or papers, impregnated with a polymeric matrix comprising at least one polymer having dispersed therein heat conducting particles. These substrates (sheets) are useful as thermally conductive printed circuit board materials or as a thermally conductive integrated circuit chip package.

### BACKGROUND OF THE INVENTION

Printed circuit boards, also known as printed wiring boards (PWB's) are described in M. W. Jawitz “Printed Circuit Board Materials Handbook”, McGraw-Hill (1997), Clyde Coombs, Jr. “Printed Circuits Handbook”, McGraw-Hill (1996) and IPC/JPCA-2315 standard “Design Guild for High Density Interconnects and Microvias” as well as many other fabrication procedures. In general, these boards comprise a dielectric layer and a metal layer. The metal can be laminated, glued, sputtered, or plated onto the board (i.e. substrate) commonly made up of a fiber-reinforced composite sheet having impregnated therein a matrix resin, such as a cross-linked epoxy. The board is then subjected to a series of steps, all known in the art, to leave a circuitized metal pattern upon the dielectric layer. The circuitized pattern serves to connect the various electronic components that can be added to make the desired electronic device. Such circuitized layers can be used alone or in a multilayer stack having vias and interlayer connections.

As electronic signals propagating through metal conductor traces, power conduits, and electronic devices are placed in close proximity, improved heat dissipation rates of the circuit board itself is required. Existing commercially available printed circuit board materials include fiberglass or non-woven para-aramid fiber reinforced papers such as Thermount® laminates available from E. I. du Pont de Nemours and Co. However, these laminates can typically have a thermal conductivity of about 0.2 Watt/m*K or below. As such, there is considerable incentive to produce a printed circuit board material having a thermal conductivity greater than about 0.5 Watt/m*K, even more preferably greater than 1.0 or 2.0 Watt/m*K.

### SUMMARY OF THE INVENTION

The present invention is directed towards a composite sheet useful as a thermally conductive electronic substrate material, said sheet comprising one or more woven or non-woven para-aramid fabrics, sheets or papers impregnated with a polymeric matrix, the polymer matrix comprising a polymer component and a thermally conductive inorganic filler component, where the composite sheet has a thermal conductivity of between any two of the following numbers 0.5, 0.6, 0.7, 0.8, 0.9, 1.0, 2.0 and 5.0 Watt/m*K, and a thickness of between about 10, 15, 20 or 25 microns to about 50, 75, 100, 125 or 150 microns.

The present invention is also directed towards composite sheets derived from at least one woven (or non-woven) fabric, sheet or paper comprising a poly(aromatic amide) component having a repeating unit of the formula:

—HN—R₁—NHOCR₂CO—

where R₁ and R₂ each represent a substituted or unsubstituted aromatic group (including homopolymers and copolymers), the woven (or non-woven) sheet fabric containing at least 10, 20, 30, or 40 to about 50, 55, 60, 65, 70 or 75 weight percent aramid fiber where at least 50 percent of the fibers has a length of about 3 to 100 mm. These aramid fibers can include p-phenylene terephthalamide, p-phenylene diphenyl ether terephthalamide, poly(m-benzamide), poly(m-phenylene isophthalamide), poly(m,m′-phenylene benzamide), and poly(1,6-naphthylene isophthalamide) fibers. The fabric sheet may optionally comprise glass-made chopped fibers or ceramic chopped fibers. Generally, these glass-made or ceramic fibers are present in the fabric sheet in an amount less than 50, 45, 40, 35, 30, 25, 20, 15, 10, 5 weight percent of the total composite sheet.

The present invention is also directed towards composite sheets (sometimes referred to as “prepregs”) comprising a base material (such as a non-woven aramid fabric) impregnated with a thermosetting (or thermoplastic) polymer matrix, the polymer matrix comprising a polymer component and a thermally conductive filler component. The polymer component can be any polymer resin. Suitable resins include, but are not limited to, epoxy, melamine, phenolic, polyimide, or unsaturated polyester resin. The amount of polymer component present in the composite sheet ranges from about 3, 5, 10 or 15 weight percent to about 20, 25 or 30 weight percent of the total composite sheet.

The present invention is also directed towards composite sheets have dispersed therein a thermally conductive filler component present in an amount between (and including) any two of the following numbers 20, 25, 30, 35, 40, 45, 50, 55, 60, 65, 70, 75 and 80 weight percent based on the total weight of the composite sheet. The composite sheets of the present invention can comprise a thermally conductive filler component that is primarily an inorganic particle(s) having a thermal conductivity between, and including, any two of the following numbers, 20, 40, 60, 80, 100 to about 100, 200, 300 or 400 Watt/m*K.

The present invention is also directed towards multilayer composite sheets that comprise at least two (or more) single composite sheets that are stacked to form the multilayer sheet. Furthermore, these multilayer sheets (or single layer sheets) can be laminated to at least one metal foil, to form a dielectric metal laminate. These dielectric metal laminates can be used as a base substrate material for a printed wiring board or as a component in an integrated circuit chip package.

### DESCRIPTION OF THE PREFERRED EMBODIMENTS

The present invention is directed towards composite sheets derived from at least one woven (or non-woven) fabric, sheet or paper comprising a poly(aromatic amide) component having a repeating unit of the formula;

—HN—R₁—NHOCR₂CO—

where R₁ and R₂ each represent a substituted or unsubstituted aromatic group (including homopolymers and copolymers), the sheet containing at least 10, 20, 30, or 40 to about 50, 55, 60, 65, 70 or 75 weight percent aramid fiber where at least 50 percent of the fibers has a length of about 3 to 100 mm. The aramid fibers of the present invention include p-phenylene terephthalamide, p-phenylene diphenyl ether terephthalamide, poly(m-benzamide), poly(m-phenylene isophthalamide), poly(m,m′-phenylene benzamide), and poly(1,6-naphthylene isophthalamide) fibers. Existing commercially available printed circuit board materials include fiberglass or non-woven para-aramid fiber reinforced papers such as Thermount® laminates available from E.I. DuPont de Nemours and Co.

The term “woven” or “non-woven” fabric (or paper) refers to a fiber sheet product that is prepared by a random or pseudo-random laying down of fibers. Such non-woven goods are well-known, including spun-bonded, spun-laced, flash spun non-woven fabrics. Papers are prepared by a process of employing short fibers in a random two-dimensional array as in the well known method for preparing cellulosic papers by an aqueous dispersion method. There is no clear distinction between papers and non-wovens in the art. The term “paper” is employed herein to refer to a short-fiber, fine denier non-woven structure isotropic in the plain having a relatively smooth surface and having a thickness of between about 10, 15, 20 or 25 microns to about 50, 75, 100, 125 or 150 microns.

The term “composite sheet” is employed herein to refer to a polymer-infused fabric or paper suitable for the practice of the invention. The term “dielectric sheet” or “dielectric layer” is used synonymously with “composite sheet.”

The term “prepreg” is a widely used term in the art of composites and refers to composite sheets that are in the uncured, or partially, cured state. The term “prepreg” represents an intermediate product that is a precursor material prior to the formation of the final composite sheets envisioned by the present invention, i.e. one where the polymer (or polymer component) is completely (or substantially completely) reacted.

The term “printed circuit board” refers to the circuitized dielectric layer having mounted upon it, or embedded within it, one or more electronic components which are interconnected by the conductive pathways disposed upon the composite sheet in the circuitized dielectric layer.

In one embodiment of the present invention, one or more cross-linkable copolymers derived from mono-vinyl hydrocarbons, conjugated dienes, and at least one thermally activatable free-radical initiator is dissolved (or dispersed) into a volatile liquid to form a solution (or dispersion). The solution (or dispersion) can then be used to form a woven, or non-woven, para-aramid or fiberglass fabric or paper.

Poly(aromatic aramid) papers useful in the practice of the present invention include para-aramid woven or non-woven papers. Suitable para-aramids include poly(p-phenylene terephthalamide) (known as PPD-T); poly(p-phenylene p,p′-biphenyldicarboxamide); poly(p-phenylene 1,5-naphthalenedicarboxamide); poly(trans,trans-4,4′-dodecahydrobiphenylene terephthalamide);poly(trans-1,4-cinnamamide); poly(p-phenylene 4,8-quinolinedicarboxamide); poly(1,4-[2,2,2]-bicyclo-octylene terephthalamide); copoly(p-phenylene 4,4′-azoxybenzenedicarboxamide/terephthalamide); poly(-p-phenylene4,4′-trans-stilbenedicarboxamide) and poly(p-phenylene acetylenedicarboxamide).

The para-aramids suitable for the practice of the present invention are conveniently made by reacting suitable monomers in the presence of an amide type solvent by low temperature techniques as taught in U.S. Pat. No. 3,063,966 to Kwolek et al, which is incorporated herein by reference. Para-aramids preferred for the present invention are homopolymers resulting from stoichiometric polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. Generally speaking, other diamines and other diacid chlorides can be used in amounts up to as much as about 30 mole percent of the p-phenylene diamine or the terephthaloyl chloride, or perhaps slightly higher, provided only that the other diamines and diacid chlorides have no reactive groups which interfere with the polymerization reaction. Also suitable are copolymers resulting from incorporation of other aromatic diamines and other aromatic diacid chlorides such as, for example, 2,6-naphthaloyl chloride or chloro- or dichloroterephthaloyl chloride; provided, only that the other aromatic diamines and aromatic diacid chlorides be present in amounts which permit preparation of anisotropic spin dopes. Preparation of p-para-aramids and processes for spinning fibers from the p-para-aramids are described in U.S. Pat. Nos. 3,869,429; 4,308,374; 4,698,414; and 5,459,231, which are incorporated herein by reference.

The para-aramids suitable for use in the present invention are spun according to the teachings of the art into fibers and optionally cut into short fibers called “floc”. The fibers or floc so formed may be formed into woven or non-woven fabrics and papers. Para-aramid papers can be formed from a mixture of para-aramid short fibers (floc) and fibrids. The floc may be composed of para Para-aramid polymer or mixtures of para and meta para-aramid polymer. Fibrids used in para-aramid papers can be non rigid film-like particles and are formed from preferably meta-para-aramid polymer. Preparation of fibrids is taught in U.S. Pat. No. 3,756,908 with a general discussion of processes to be found in U.S. Pat. No. 2,999,788. Fibrids are used as a binder for the para-para-aramid flocs in paper-making. The concentration of floc and fibrids in the paper may range from 45 to 97% by weight floc and from 3 to 30% by weight fibrids. It is preferred that the para-para-aramid floc be poly(p-phenylene terephthalamide) and the meta para-aramid be poly(m-phenylene isophthalamide).

In one embodiment of the present invention a para-aramid paper comprising from about 5 to 25 weight percent poly(m-phenylene-isophthalamide) fibrids and 75 to 95 weight percent p-para-aramid floc and having a basis weight of between 0.8 to 4.0 oz/yd2 is used as the poly(aromatic aramid) sheet. Para-aramid papers prepared according to the methods in U.S. Pat. No. 5,910,231 are generally preferred as the poly(aromatic aramid) sheets of the present invention. Also suitable for use in the present invention are fiberglass non-woven or woven fabrics, sheets or papers. Numerous such materials are in wide spread use in the art and available commercially from numerous sources.

In one embodiment of the present invention, a non-thermally conductive poly(aromatic aramid) fiber sheet is formed via a process known to the prior art. Next, a polymer matrix is formed, the polymer matrix comprising a thermally conductive filler component and a polymer component. Useful polymers used as the polymer component in accordance with the present invention include, but are not limited to, polyester (unsaturated and saturated), melamine, polyesteramide, polyesteramideimide, polyimide, polybenzoxazole, polybenzimidazole, polybenzthiazole, polyethersulfone, polyamide, polyamideimide, polyetherimide, polycarbonate, polysulfone, polyether, polyetherketone, acrylics, epoxies, phenolics, polytetrafluoroethylene (PTFE), tetrafluoroethylene hexafluoropropylene copolymer (FEP), tetrafluoroethylene perfluoroalkylvinylether copolymer (PFA), ethylene tetrafluoroethylene copolymer (ETFE), ethylene chlorotrifluoroethylene copolymer (ECTFE), polyvinylidene fluoride (PVDF), and polymer alloys of these. Generally, the polymer component is present with the composite sheets of the present invention in an amount ranging from about 3, 5, 10 or 15 weight percent to about 20, 25 or 30 weight percent of the total composite sheet.

The polymer component of the present invention can optionally further comprise additional additives, including processing aids (e.g., plasticizers), antioxidants, light stabilizers, flame retardant additives, anti-static agents, heat stabilizers, ultraviolet absorbing agents or various reinforcing agents.

Since a wide variety of polymers can be used to form a polymer matrix in accordance with the practice of the present invention, there can be a wide variety of processing techniques and processing conditions used. Processing techniques and conditions would be specifically tailored to what polymer was chosen and each particular polymer could require a different set of processing conditions to form a thermally conductive composite sheet.

The polymer matrix of the present invention also comprises a thermally conductive filler component. The thermally conductive filler component can be an inorganic material, sometimes a metal oxide, having an average size (dispersed within the polyimide matrix) in a range between (and including) any two of the following sizes: 50, 55, 60, 65, 70, 75, 80, 85, 90, 95, 100, 125, 150, 175, 200, 250, 300, 350, 400, 450, 500, 1,000, 10,000 and 20,000 nanometers.

Thermally conductive filler of the present invention is selected primarily to provide the composite sheet with good thermal conductivity. Since boron nitride is widely accepted in the industry as a useful thermally conductive filler material, it is particularly mentioned herein. However, the present invention does anticipate the use of other fillers as being good thermally conductive fillers. These fillers include (but not limited to) silica, boron nitride coated aluminum oxide, granular alumina, granular silica, fumed silica, silicon carbide, aluminum nitride, aluminum oxide coated aluminum nitride, titanium dioxide and combinations thereof. Other useful fillers include, glass fiber, aluminum oxide, zinc oxide, aluminum, silver, diamond and metal-coated diamond.

In one embodiment of the present invention, thermally conductive filler is mixed with the polymer component to form a polymer matrix. The polymer matrix is then added to a mixture of cross-linkable copolymers derived from a mixture of monovinyl hydrocarbons, conjugated dienes, and at least one thermally activated free-radical initiator. These materials (after adequate mixing and/or dispersion) can then be molded into a thermally conductive poly(aromatic aramid) based composite sheet. After forming the composite sheet, if the polymer component is in its uncured state (i.e. not fully reacted) then the composite sheet is referred to as a ‘pre-preg’ composite sheet. Alternatively, the polymer component can be fully cured either through a thermal or chemical curing method to form a thermally conductive composite sheet.

In another embodiment of the present invention, thermally conductive filler component (i.e. boron nitride particles) can be first dispersed in a solvent to form slurry. The slurry can then be dispersed in a polymer component to form a polymer matrix. The amount of thermally conductive filler component in the polymer matrix can be in the range of between any two of the following numbers 30, 35, 40, 45, 50, 55, 60, 65, 70, 75, 80, 85 or 90 weight percent. Next, the polymer matrix can then be coated onto an already existing porous or non-porous poly(aromatic aramid) based sheet using any one of many known coating methods, these coating methods including, but not limited to, spray coating, roller coating, doctor-blade coating, direct casting via a slot extrusion die and others. Optionally, the already coated poly(aromatic aramid) sheet can then be roll annealed (or pressed) to further infuse the polymer matrix into the woven (or non-woven sheet) fabric sheet. In addition, the polymeric matrix can be cast to form a ‘green film’ (i.e. a film that is not fully cured) where the ‘green film’ is then laid up and laminated to a poly(aromatic aramid) fiber sheet and pressed at high temperature and pressure to form the final composite sheet.

As used herein, the combination of the polymer component and the thermally conductive filler component is referred to herein as a polymer matrix or polymer matrix component. Typically, these polymer matrix dispersions are well mixed enough so that the average particle size of the thermally conductive filler particle is adequately reduced so that a stable dispersion is formed. Thermally conductive filler component can be uniformly dispersed so that the average particle size of the filler in an organic solvent compatible with the polymer component (or the polymer component) is between greater than about 10, 20, 30, 40 or 50 nanometers to less than about 1.0, 2.0, 3.0, 5.0, 10 or 20 microns. Generally speaking, filler component that is not adequately dispersed (e.g. a filler component that contains large agglomerates) can oftentimes degrade or defeat the functional aspects sought after in the composite sheet.

In another embodiment of the present invention, a polyimide is used as the polymer component. Polyimides can be derived from dianhydrides and diamines. These dianhydrides and diamines can also be particularly selected to provide the final polyimide component with specifically desired properties. One particularly useful property is a low glass transition temperature to provide good adhesivity. Useful glass transition temperatures for good adhesivity can include any temperature between, and including, any two of the following numbers, 250, 240, 230, 220, 210, 200, 190, 180, 170, 160, 150, 140, 130, 120, 110 and 100° C. In another embodiment, if higher modulus is more important in the composite sheet, a polyimide having no glass transition temperature or a glass transition temperature between any two of these two numbers, 550, 530, 510, 490, 470, 450, 430, 410, 390, 370, 350, 330, 310, 290, 270, and 250° C. can be useful.

If polyimide is used as the polymer component in this invention, the polyimide can be synthesized by first forming a polyimide precursor material, typically a polyamic acid solution by reacting (in the presence of a solvent system) one or more dianhydride monomers and one or more diamine monomers.

Useful organic solvents, for the synthesis of a polyimide-based polymeric matrix in accordance with the practice of the present invention should be capable of dissolving a polyimide precursor material (e.g. a polyamic acid). Such a solvent should also have a relatively low boiling point, such as below 225° C., so the polyimide precursor can be dried and cured at a moderate temperature (i.e., more convenient and less costly). A boiling point of less than 210, 205, 200, 195, 190, or 180° C. is preferred. Useful solvents include, but are not limited to, N-methylpyrrolidone (NMP), dimethyl-pyrrolidin-3-one, dimethylacetamide (DMAc), N,N′-dimethyl-formamide (DMF), dimethyl sulfoxide (DMSO), tetramethyl urea (TMU), hexamethylphosphoramide, dimethylsulfone, tetramethylene sulfone, gamma-butyrolactone, and pyridine. In one embodiment, preferred solvents include N-methylpyrrolidone (NMP) and dimethylacetamide (DMAc), however solvent selection is typically dictated by which polymer component is chosen.

As used herein, the term ‘polyimide component’ is intended to include any polyimide precursor material, polyimide, polyimide ester, or polyimide ether ester synthesized by a poly-condensation reaction involving the reaction of at least one or more aromatic or cyclo-aliphatic dianhydrides (or derivations thereof suitable for synthesizing these) with at least one or more aromatic, cycloaliphatic or aliphatic diamines (or derivations thereof suitable for synthesizing these).

Useful diamines used to form polyimide-based polymer components in accordance with the practice of this invention include, but are not limited to:
1. 2,2 bis-(4-aminophenyl) propane;
2. 4,4′-diaminodiphenyl methane;
3. 4,4′-diaminodiphenyl sulfide;
4. 3,3′-diaminodiphenyl sulfone (3,3′-DDS);
5. 4,4′-diaminodiphenyl sulfone (4,4′-DDS);
6. 4,4′-diaminodiphenyl ether (4,4′-ODA);
7. 3,4′-diaminodiphenyl ether (3,4′-ODA);
8. 1,3-bis-(4-aminophenoxy) benzene (APB-134 or RODA);
9. 1,3-bis-(3-aminophenoxy) benzene (APB-133);
10. 1,2-bis-(4-aminophenoxy) benzene;
11. 1,2-bis-(3-aminophenoxy) benzene;
12. 1,4-bis-(4-aminophenoxy) benzene;
13. 1,4-bis-(3-aminophenoxy) benzene;
14. 1,5-diaminonaphthalene;
15. 1,8-diaminonaphthalene;
16. 2,2′-bis(trifluoromethyl)benzidine;
17. 4,4′-diaminodiphenyldiethylsilane;
18. 4,4′-diaminodiphenylsilane;
19. 4,4′-diaminodiphenylethylphosphine oxide;
20. 4,4′-diaminodiphenyl-N-methyl amine;
21. 4,4′-diaminodiphenyl-N-phenyl amine;
22. 1,2-diaminobenzene (OPD);
23. 1,3-diaminobenzene (MPD);
24. 1,4-diaminobenzene (PPD);
25. 2,5-dimethyl-1,4-diaminobenzene;
26. 2-(trifluoromethyl)-1,4-phenylenediamine;
27. 5-(trifluoromethyl)-1,3-phenylenediamine;
28. 2,2-Bis[4-(4-aminophenoxy)phenyl]-hexafluoropropane (BDAF);
29. 2,2-bis(3-aminophenyl)1,1,1,3,3,3-hexafluoropropane;
30. benzidine;
31. 4,4′-diaminobenzophenone;
32. 3,4′-diaminobenzophenone;
33. 3,3′-diaminobenzophenone;
34. m-xylylene diamine;
35. bisaminophenoxyphenylsulfone;
36. 4,4′-isopropylidenedianiline;
37. N,N-bis-(4-aminophenyl)methylamine;
38. N,N-bis-(4-aminophenyl)aniline
39. 3,3′-dimethyl-4,4′-diaminobiphenyl;
40. 4-aminophenyl-3-aminobenzoate;
41. 2,4-diaminotoluene;
42. 2,5-diaminotoluene;
43. 2,6-diaminotoluene;
44. 2,4-diamine-5-chlorotoluene;
45. 2,4-diamine-6-chlorotoluene;
46. 4-chloro-1,2-phenylenediamine;
47. 4-chloro-1,3-phenylenediamine;
48. 2,4-bis-(beta-amino-t-butyl)toluene;
49. bis-(p-beta-amino-t-butyl phenyl)ether;
50. p-bis-2-(2-methyl-4-aminopentyl)benzene;
51. 1 -(4-aminophenoxy)-3-(3-aminophenoxy)benzene;
52. 1 -(4-aminophenoxy)-4-(3-aminophenoxy)benzene;
53. 2,2-bis-[4-(4-aminophenoxy)phenyl]propane (BAPP);
54. bis-[4-(4-aminophenoxy)phenyl]sulfone (BAPS);
55. 2,2-bis[4-(3-aminophenoxy)phenyl]sulfone (m-BAPS);
56. 4,4′-bis-(aminophenoxy)biphenyl (BAPB);
57. bis-(4-[4-aminophenoxy]phenyl)ether (BAPE);
58. 2,2′-bis-(4-aminophenyl)-hexafluoropropane (6F diamine);
59. bis(3-aminophenyl)-3,5-di(trifluoromethyl)phenylphosphine oxide
60. 2,2′-bis-(4-phenoxy aniline)isopropylidene;
61. 2,4,6-trimethyl-1,3-diaminobenzene;
62. 4,4′-diamino-2,2′-trifluoromethyl diphenyloxide;
63. 3,3′-diamino-5,5′-trifluoromethyl diphenyloxide;
64. 4,4′-trifluoromethyl-2,2′-diaminobiphenyl;
65. 4,4′-oxy-bis-[(2-trifluoromethyl)benzene amine];
66. 4,4′-oxy-bis-[(3-trifluoromethyl)benzene amine];
67. 4,4′-thio-bis-[(2-trifluoromethyl)benzene-amine];
68. 4,4′-thiobis-[(3-trifluoromethyl)benzene amine];
69. 4,4′-sulfoxyl-bis-[(2-trifluoromethyl)benzene amine];
70. 4,4′-sulfoxyl-bis-[(3-trifluoromethyl)benzene amine];
71. 4,4′-keto-bis-[(2-trifluoromethyl)benzene amine];
72. 9,9-bis(4-aminophenyl)fluorene;
73. 1,3-diamino-2,4,5,6-tetrafluorobenzene;
74. 3,3′-bis(trifluoromethyl)benzidine;
75. 3,3′-diaminodiphenylether;
76. and the like.

Other useful diamines used in conjunction with the above or alone are 1,6-hexamethylene diamine, 1,7-heptamethylene diamine, 1,8-octamethylenediamine, 1,9-nonamethylenediamine, 1,10-decamethylenediamine (DMD), 1,11 -undecamethylenediamine, 1,12-dodecamethylenediamine (DDD), 1,16-hexadecamethylenediamine, 1,3-bis(3-aminopropyl)-tetramethyldisiloxane, α,ω-bis(3-aminopropyl)polydimethylsiloxane, isophoronediamine, and combinations thereof. In order to achieve a low temperature bonding) diamines comprising ether linkages and or diamines comprising aliphatic functional groups are used. The term low temperature bonding is intended to mean bonding two materials in a temperature range of from about 180, 185, or 190° C. to about 195, 200, 205, 210, 215, 220, 225, 230, 235, 240, 245 and 250° C.).

Useful dianhydrides used to form polyimide-based polymer components in accordance with the present invention include, but are not limited to:
1. pyromellitic dianhydride (PMDA);
2. 3,3′,4,4′-biphenyl tetracarboxylic dianhydride (BPDA);
3. 3,3′,4,4′-benzophenone tetracarboxylic dianhydride (BTDA);
4. 4,4′-oxydiphthalic anhydride (ODPA);
5. 3,3′,4,4′-diphenylsulfone tetracarboxylic dianhydride (DSDA);
6. 2,2-bis(3,4-dicarboxyphenyl)1,1,1,3,3,3-hexafluoropropane dianhydride (6FDA);
7. 4,4′-(4,4′-isopropylidenediphenoxy)bis(phthalic anhydride) (BPADA);
8. 2,3,6,7-naphthalene tetracarboxylic dianhydride;
9. 1,2,5,6-naphthalene tetracarboxylic dianhydride;
10.1,4,5,8-naphthalene tetracarboxylic dianhydride;
11. 2,6-dichloronaphthalene-1,4,5,8-tetracarboxylic dianhydride;
12. 2,7-dichloronaphthalene-1,4,5,8-tetracarboxylic dianhydride;
13. 2,3,3′,4′-biphenyl tetracarboxylic dianhydride; 14. 2,2′,3,3′-biphenyl tetracarboxylic dianhydride;
15. 2,3,3′,4′-benzophenone tetracarboxylic dianhydride;
16. 2,2′,3,3′-benzophenone tetracarboxylic dianhydride;
17. 2,2-bis(3,4-dicarboxyphenyl)propane dianhydride;
18. 1,1-bis(2,3-dicarboxyphenyl)ethane dianhydride;
19. 1,1-bis(3,4-dicarboxyphenyl)ethane dianhydride;
20. bis-(2,3-dicarboxyphenyl)methane dianhydride;
21. bis-(3,4-dicarboxyphenyl)methane dianhydride;
22. 4,4′-(hexafluoroisopropylidene)diphthalic anhydride;
23. bis-(3,4-dicarboxyphenyl)sulfoxide dianhydride;
24. tetrahydrofuran-2,3,4,5-tetracarboxylic dianhydride;
25. pyrazine-2,3,5,6-tetracarboxylic dianhydride;
26. thiophene-2,3,4,5-tetracarboxylic dianhydride;
27. phenanthrene-1,8,9,10-tetracarboxylic dianhydride;
28. perylene-3,4,9,10-tetracarboxylic dianhydride;
29. bis-1,3-isobenzofurandione;
30. bis-(3,4-dicarboxyphenyl)thioether dianhydride;
31. bicyclo[2,2,2]oct-7-ene-2,3,5,6-tetracarboxylicdianhydride;
32. 2-(3′,4′-dicarboxyphenyl)5,6-dicarboxybenzimidazole dianhydride;
33. 2-(3′,4′-dicarboxyphenyl)5,6-dicarboxybenzoxazole dianhydride;
34. 2-(3′,4′-dicarboxyphenyl)5,6-dicarboxybenzothiazole dianhydride;
35. bis-(3,4-dicarboxyphenyl)2,5-oxadiazole 1,3,4-dianhydride;
36. bis-2,5-(3′,4′-dicarboxydiphenylether)1,3,4-oxadiazole dianhydride;
37. bis-2,5-(3′,4′-dicarboxydiphenylether)1,3,4-oxadiazole dianhydride;
38. 5-(2,5-dioxotetrahydro)-3-methyl-3-cyclohexene-1,2-dicarboxylic anhydride;
39. trimellitic anhydride 2,2-bis(3′,4′-dicarboxyphenyl)propane dianhydride;
40. 1,2,3,4-cyclobutane dianhydride;
41. 2,3,5-tricarboxycyclopentylacetic acid dianhydride;
42. their acid ester and acid halide ester derivatives;
43. and the like.

Dianhydride and diamines can be particularly selected to provide a polyimide-based polymer matrix with specifically desired properties. One such useful property is for the polyimide-based polymer matrix to have a certain glass transition temperature (Tg). A useful Tg can be between and including any two of the following numbers, 250, 240, 230, 220, 210, 200, 190, 180, 170, 160, 150, 140, 130, 120, 110 and 100° C. Another useful range, if adherability is less important than other properties, is from 550, 530, 510, 490, 470, 450, 430, 410, 390, 370, 350, 330, 310, 290, 270, and 250° C. Some useful diamines here can include APB-134, APB-133, 3,4′-ODA, BAPP, BAPE, BAPS and many aliphatic diamines. As such, the selection of dianhydride and diamine component is important to customize what final properties of the polymer binder are specifically desired. Some useful dianhydrides include BPADA, DSDA, ODPA, BPDA, BTDA, 6FDA, and PMDA or mixtures thereof. These dianhydrides are readily commercially available and generally provide acceptable performance.

In one embodiment of the present invention, a dispersing agent can be used to assist the incorporation of the filler component into the polymer component and thus the composite sheet. In one such embodiment, a dispersing agent is added to an organic solvent, or co-solvent mixture (or solvent system) to form a dispersing solution. The dispersion solution comprises some concentration of dispersing agent typically between any two of the following numbers 0.1, 0.5, 1.0, 2.0, 4.0, 5.0, 10.0, 15.0 and 20.0 weight percent dispersing solution. The dispersing solution can then be used to disperse (along with shearing force if necessary) the filler component into the solvent.

Generally speaking, so long as the thermally conductive filler is sufficiently dispersible in the polyimide precursor material (e.g. a polyamic acid solution), the filler can be dispersed prior to, during, or after the polyamic acid solution is formed. This is generally true at least until the imidization of the polyimide (i.e. solvent removal and curing of the polyamic acid to a polyimide) where increasing viscosity prohibits adequate dispersion of the filler within the polymer matrix.

In one embodiment of the present invention, it is preferable to use a heating system having a plurality of heating sections or zones to process a pre-preg composite sheet or the constituents necessary to form the pre-preg if the practitioner desires to cure the polymer to its final form. In the case of the polymer component being a polyimide, it is generally preferable that the maximum heating temperature be controlled to give a maximum air (or nitrogen) temperature of the ovens from about 200 to 600° C., more preferably from 350 to 500° C. By regulating the maximum curing temperature within the range as defined above, it is possible to convert the polyamic acid to a polyimide having good mechanical strength, adhesive character, and thermal dimensional stability.

Alternatively, heating temperatures can be set to between 200-600° C. while varying the heating time. Regarding curing time, it can be preferable that the polyimides of the present invention be exposed to a maximum heating temperature for about 1, 2, 3, 5, 10, 15, 20, 25, 30, 35, 40, 45 or 50 seconds to about 60, 70, 80, 90, 100, 200, 400, 500, 700, 800, 900, 1000, 1100 or 1200 seconds (the length of time depending on heating temperature). The heating temperature may be changed stepwise so as not to wrinkle a film by drying it too quickly.

In general, the composite sheets of the present invention can be used in a variety of applications and uses. One such use is where the composite sheet has superior thermal conductivity, i.e. where the filler component is an inorganic particle having a thermal conductivity of between and including any two of the following numbers, 20, 50, 100, 150, 200, 250, 300, 350 and 400 watts/(meter*K) where the composite sheet layer has a thermal conductivity of between and including any two of the following numbers 0.5, 0.6, 0.7, 0.8, 0.9, 1.0, 1.1, 1.2, 1.3, 1.4, 1.5, 1.6, 1.7, 1.8, 1.9, 2.0, 3.0, 4.0 and 5.0 watts/(meter*K).

The composite sheets of the present invention can be excellent dielectrics that can be used to form a metal laminate, or may also be used as a stand-alone sheet in other designs requiring good thermal conductivity from a dielectric layer. A single layer metal-clad of the present invention can typically comprise at least one composite sheet adhered to at least one metal foil. Foils such as these are derived from metals including, but not limited to, copper, aluminum, nickel, steel or an alloy foil containing one or more of these metals. In some cases, the composite sheet can adhere firmly to the metal, having peel strengths of greater than 2 pounds per linear inch and higher, without using an adhesive. The metal may be adhered to one or both sides of the composite sheet. In other cases, an adhesive can be used to laminate the composite sheet to a metal layer. Common adhesives used to bond the composite sheet to a metal foil (if an adhesive is needed) are polyimide-based adhesive, acrylic-based adhesives or epoxies.

As used herein, the term “conductive layers” and “conductive foils” are meant to be metal layers or metal foils. Conductive foils are typically metal foils. Metal foils do not have to be used as elements in pure form; they may also be used as metal foil alloys, such as copper alloys containing nickel, chromium, iron, and other metals. Other useful metals include, but are not limited to, copper, nickel, steel, aluminum, brass, a copper molybdenum alloy, Kovar®, Invar®, a bimetal, a trimetal, a tri-metal derived from two-layers of copper and one layer of Invar®, and a trimetal derived from two layers of copper and one layer of molybdenum.

Generally, the composite sheets of the present invention are useful as a single-layer base substrate (a dielectric) in an electronic device requiring good thermal conductivity of the dielectric material. Examples of such electronic devices include (but are not limited) thermoelectric modules, thermoelectric coolers, DC/AC and AC/DC inverters, DC/DC and AC/AC converters, power amplifiers, voltage regulators, igniters, light emitting diodes, IC packages, and the like.

### EXAMPLES

Thermal conductivity data for the composite sheets of the present invention was measured using a ‘nanoflash’ method. As used herein, the nanoflash method refers to using optical coupling to heat and read a sample's surface (i.e. eliminating the need to use an interface thermal resistance method). Thermal conductivity κ(in W/m-K) is secondary data derived from the relationship that κ=α·ρ·Cₚ. Thermal diffusivity a (in mm²/s) is measured along with specific heat Cₚ (in J/g-K). A sample measuring 25.4 mm round is irradiated uniformly on one side from a xenon-tube flash tube pulse. Heat rises on the opposite side of the sample and is measured as a function time using an InSb IR detector. Analysis uses Cowan+pulse correction method to get the best fit possible of the heat rise curve. For the samples of the present invention, the samples were sputtered ˜600 Å with gold on both sides to as contain the blindness of IR detector to the lamp flash. The gold sputtered films were then sprayed with graphite on both sides to minimize the heat reflection and to maximize the heat absorption and to increase the surface uniformity.

### EXAMPLES

### Polymer A Preparation

0.3 mole (87.7 gm) of 1,3-bis-(4-aminophenoxy)benzene (APB-134) is dissolved in 750 ml of Dimethyl acetamide (DMAc) solvent using a 1 liter beaker. The beaker is placed in dry box and well stirred.

A mixture of 0.24 mole (74.46 g) 4,4′-oxydiphthalic anhydride (ODPA) and 0.06 mole (13.08 g) of pyromellitic dianhydride (PMDA) is prepared as the dianhydride mixture. Ninety five percent of the dianhydride mixture is slowly added to the diamine solution over a period of 15 minutes. The temperature of the solution is allowed to rise over 40° C. The viscosity of this polymer (A) is about 50 poise.

Viscosity of a portion of polymer A (150 gm) is further increased to100 poise by adding PMDA. This polymer is coated on highly porous thin Kevlar*, or Thermount* paper. It is then dried at 80° C. and cured in an oven following a heating profile at a ramp rate of 5° C./min up to 350° C. This composite sheet is used as a control for thermal conductivity measurement. The composite with thermoplastic polyimide is also laminated with copper foils at 350° C./350 psi to make flexible copper laminates for making flexible printed circuits.

A portion of the polymer (150 gm) solution A is mixed with boron nitride, HCPL grade BN (30 gm; 50%) and dispersed very well using Silversion mixer. Then the polymer viscosity is raised to 100 poise by slowly adding PMDA solution. This slurry is either coated on a glass plate to make an independent film, or coated/impregnated onto a very thin Kevlar* paper (Thermount*) supported on a glass plate to make a composite. It is then dried (at 80° C.) on a hot plate and cured in an oven at a rate of 5° C./min until the temp reached 350° C. This composite also is laminated with copper foils at 350° C./350 psi to make copper laminates.

### Polymer B Preparation

0.015 mole (3 g) of 4,4′-Oxy di-aniline (ODA) and 0.285 mole (30.8 g) of para-phenylene diamine (PPD) dissolved in 510 ml of Dimethyl acetamide (DMAc) solvent using a 1 liter beaker. The beaker is placed in dry box and well stirred.

A mixture of 0.264 mole (77.7 g) 3,3′,4,4′-Biphenyl anhydride (BPDA) and 0.036 mole (7.85 g) of pyromellitic dianhydride (PMDA) is prepared as the dianhydride mixture. Ninety five percent of the dianhydride mixture is slowly added to the diamine solution over a period of 15 minutes. The temperature of the solution is allowed to rise over 40° C. The viscosity of this polymer B is about 50 poise.

Viscosity of a portion of polymer B (150 gm) is further increased to100 poise by adding PMDA. This polymer is coated on highly porous thin Kevlar*, or Thermount* paper. It is then dried at 80° C. and cured in an oven following a heating profile at a ramp rate of 5° C./min up to 350° C. This composite sheet is used as a control for thermal conductivity measurement.

A portion of the polymer (150 gm) solution B is mixed with boron nitride, HCPL grade BN (90 g; 75%) and dispersed very well using Silversion mixer. Then the polymer viscosity is raised to 100 poise by slowly adding PMDA solution. This slurry is either coated on a glass plate to make an independent film, or coated/impregnated onto a very thin Kevlar* paper (Thermount*) supported on a glass plate to make a composite. It is then dried (at 80° C.) on a hot plate and cured in an oven at a rate of 5° C./min until the temp reached 350° C.

A portion of the polymer (150 gm) solution B is mixed with boron nitride, HCPL grade BN (90 g; 75%) and dispersed very well using Silversion mixer. Then the polymer viscosity is raised to 100 poise by slowly adding PMDA solution. This slurry is coated/impregnated onto a very thin Kevlar* paper (Thermount*) supported on a glass plate to make a composite. Then a thin coating of thermoplastic polyamic acid solution filled with 40% BN is applied. The coating is dried and cured by raising the temperature up to 350° C. This process is repeated to make several composites with different loading levels of boron nitride.

The composite sheets are tested for thermal conductivity. Thermal conductivities of these composite structures are measured using nano-flash technique. Thermal conductivities varied depending on the filler loading level, type of filler, thickness of the composites, etc. Results are shown in Table 1.

TABLE 1

| | | Thermal |
|---|---|---|
| | | conductivity, |
| Composition | Inorganic filler, % in the PI film | W/m · K |
| Polymer A coated on | 0 | 0.24 |
| Kevlar paper (Control) | | |
| Polymer film A at | 52.6% Alumina | 0.44 |
| 20um thickness | | |
| 22um thick film | 52.6% Alumina | 0.507 |
| 25um thick film | 52.6% Alumina | 0.55 |
| Polymer A + Kevlar* | 40% HCPL BN | 0.53 |
| Polymer A + Kevlar* | 50% HCPL BN | 1.2 |
| Polymer B + Kevlar* | 75% HCPL BN | 9.78 |
| Polymer B + Kevlar* + | 75% BN in impregnating | 0.92 |
| Polymer A on top | polymer B and and | |
| | coating polymer A | |
| | containing 40% BN for bonding | |

We claim:

1. A composite sheet comprising a poly(aromatic amide) component having a repeating unit of the formula;
—HN—R₁—NHOCR₂CO—
wherein R₁ and R₂ represent either a substituted or unsubstituted aromatic group, the composite sheet being impregnated with a polymer matrix comprising a polymer component and a thermally conductive filler component, wherein the composite sheet has a thermal conductivity of 0.5 to 5.0 Watt/m*K.

2. A sheet in accordance with claim 1 wherein the poly(aromatic amide) component is present in an amount ranging from 10 to 75 weight percent.

3. A sheet in accordance with claim 1 wherein the poly(aromatic amide) component comprises aramid fibers.

4. A sheet in accordance with claim 1 wherein the poly(aromatic amide) component comprises aramid fibers wherein at least 50 percent of the fibers have a length of about 3 to 100 mm.

5. A sheet in accordance with claim 1 wherein the poly(aromatic amide) component is a polymer selected from the group consisting of p-phenylene terephthalamide, p-phenylene diphenyl ether terephthalamide, poly(m-benzamide), poly(m-phenylene isophthalamide), poly(m,m′-phenylene benzamide), and poly(1,6-naphthylene isophthalamide).

6. A sheet in accordance with claim 1 wherein the sheet has a thickness of between 10 to 150 microns.

7. A sheet in accordance with claim 1 wherein the polymer component is present in amount ranging from 3 to 30 weight percent.

8. A sheet in accordance with claim 1 wherein the polymer component is selected from the group consisting of polyester (unsaturated and saturated), melamine, polyesteramide, polyesteramideimide, polyimide, polybenzoxazole, polybenzimidazole, polybenzthiazole, polyethersulfone, polyamide, polyamideimide, polyetherimide, polycarbonate, polysulfone, polyether, polyetherketone, acrylics, epoxies, phenolics, polytetrafluoroethylene (PTFE), tetrafluoroethylene hexafluoropropylene copolymer (FEP), tetrafluoroethylene perfluoroalkylvinylether copolymer (PFA), ethylene tetrafluoroethylene copolymer (ETFE), ethylene chlorotrifluoroethylene copolymer (ECTFE), polyvinylidene fluoride (PVDF), and polymer alloys of these.

9. A sheet in accordance with claim 1 wherein the polymer component is a polyimide having a glass transition temperature between 150 and 350° C.

10. A sheet in accordance with claim 1 wherein the thermally conductive filler is present in an amount ranging from 20 to 80 weight percent.

11. A sheet in accordance with claim 1 wherein the thermally conductive filler is present in a amount ranging from 40 to 70 weight present of the total sheet.

12. A sheet in accordance with claim 1 wherein the thermally conductive filler component is an inorganic particle having a thermal conductivity of between about 20 and 400 Watt/m*K.

13. A sheet in accordance with claim 1 wherein the thermally conductive filler component is selected from the group consisting of aluminum oxide, silica, boron nitride, granular alumina, fumed alumina, silicon carbide, aluminum nitride, beryllium oxide, boron nitride coated aluminum oxide, boron nitride coated aluminum nitride and aluminum oxide coated aluminum nitride.

14. A sheet in accordance with claim 1 wherein the thermally conductive filler component is an inorganic particle having an average diameter particle size of between 50 to 10,000 nanometers.

15. A sheet in accordance with claim 1 wherein the sheet is useful as a single layer or multilayer printed wiring board.

16. A sheet in accordance with claim 1 wherein the sheet is useful as a component in an integrated circuit chip package.

17. A sheet in accordance with claim 1 wherein the sheet has a thermal conductivity between 0.5 and 1.0 Watt/m*K.

18. A sheet in accordance with claim 1 wherein the sheet has a coefficient of thermal expansion between 10 and 25 ppm/° C.

19. A multilayer sheet made by compression molding at least two sheets in accordance with the sheet of claim 1.

20. A laminate comprising at least one metal foil and at least one sheet in accordance with claim 1.

21. A laminate comprising a multilayer sheet in accordance with claim 19 and at least one metal foil.
